(19) United States
(12) Patent Application Publication
(10) Pub. No.: US 2004/0149578 A1
(43) Pub. Date: Aug. 5, 2004

(54) Method for manufacturing electrochemical sensor and structure thereof

(76) Inventor: Chun-Mu Huang, Sanchung City (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/354,684

(22) Filed: Jan. 30, 2003

(51) Int. Cl. G01N 27/26

(52) U.S. Cl. 204/403.01; 204/416; 29/592.1

(57) ABSTRACT

A method for manufacturing an electrochemical sensor and a structure thereof are provided. The method includes steps of (a) providing an injection-molding device, (b) providing an isolating substrate having a first recess and a first through hole, (c) positing the isolating substrate in the injection-molding device, (d) injecting a conductive plastic material into the injection-molding device for forming a conductive strip disposed in the first recess and including an output terminal and a testing electrode disposed in the first through hole, (e) providing a chemical reagent, and (f) positing the chemical reagent on the testing electrode for testing a sample solution.

### FIELD OF THE INVENTION

The present invention is related to a method for manufacturing an electrochemical sensor and a structure thereof, more particularly to a structure of a method for manufacturing a disposable electrochemical sensor serving to detect a fluid sample and a structure thereof.

### BACKGROUND OF THE INVENTION

Electrochemical sensors have been applied for examining the analyte in a sample solution of various biochemical fluid samples for several decades. An electrochemical sensor equipment of a laboratory usually includes several different apparatus for different examining functions. Please refer to FIG. 1. It illustrates a basic electrochemical sensor equipment including:

1. a carrying container 12 to be an electrochemical examining section 13 for disposing a fluid sample 11;

2. a reagent 14 to analyze a specific analyte of the fluid sample 11 by means of a chemical reaction for producing an outputting signal of an electric parameter in relation to the concentration of the analyte in the fluid sample 11, wherein the fluid sample 11 could be the blood of a human, the analyte could be a concentration of the blood glucose, and the reagent 14 could be a glucose oxidase or their compounds;

3. plural testing electrodes—a counter electrode 15, a working electrode 16 and a reference electrode 17 for example, for introducing a working voltage of a electrochemical reaction form a meter 18 to a chemical reactor 12, wherein the electric parameter of the fluid sample 11 is introduced to the meter 18 via the electrodes.

4. an electrochemical meter 18 to provide a working voltage or a working current for the electrochemical reaction, and receive an electric parameter(outputting current or voltage) after the electrochemical reaction, then recording a result of the parameter analysis and the showing data.

Meanwhile plural testing electrodes could include a counter electrode and a working electrode only or further includes a reference electrode. Moreover, a detecting electrode could be included as a fourth electrode. The number of the plural testing electrodes is varied according to the requirement of the electrochemical reaction.

The electrodes of different functions are made of different materials. In the laboratory, the counter electrode 15 is made of any conductive material such as a copper, a silver, a nickel, a graphite, a carbon, a gold, a platinum or other conductive material. The most structure of a reference electrode 17 includes a modified electrode 171 produced by means of printing or electroplating an Ag/AgCl film.

The working electrode 16 is more complex and can be sorted to two types. One is a metal-catalyzed electrode, made of a gold, a platinum, a palladium, and a rhodium, wherein the working electrode is not for conduction only, it could catalyze the electrochemical reaction between the chemical reagent and a specific analyte, and it would merely catalyze with the specific analyte and thereby the measuring electric parameter for a specific analyte should be enlarge and more distinct. Another is an electron-transfer mediator modified working electrode, it is so called enzyme electrode which is a compound immobilized several chemical reagents (the reagent includes enzyme an their compounds) on the surface of the working electrode and being reactive with the specific analyte, wherein the electric parameter produced from the electrochemical reaction is transmitted via the working electrode with the simple function of conduction. The material of the electrode should be selected specifically from a group, which wouldn't chemical react with the fluid sample 11 or the chemical reagent 14 thereby interfering with the result. The electrode could be made of a noble metal (i.e. a gold, a platinum, a palladium, and a rhodium), a carbon base screen print electrode, and a graphite bar, wherein a carbon and the noble metal aren't chemical reactive in a low temperature and won't interfere with the result.

FIG. 1 illustrates an electrochemical sensor apparatus including three electrodes and a measuring circuit disposed in the meter 18. The meter 18 provides a voltage E transmitted to electrodes 15, 16, and 17 via lead wires to be an electrochemical working voltage for the analyte of the fluid sample 11 and the chemical reagent 14. The analyte and the chemical reagent 14 react to produce a measuring parameter that is a diffusing current i, which is in proportion to the concentration C of the analyte. The relationship of i and C could be simplified as the following equation:

i(t)=n×F×A×f(C)×f(D)×f(X) ×f(t),

wherein i is the measure current;

n is the number of transfer electrons;

F is the Faraday constant;

A is the surface area of the working electrode;

D is the diffusion coefficient;

C is the concentration of the analyte;

X is the thickness of the reagent; and

t is the time from start measure.

Meanwhile the current i is in a linear reaction to n, F and A, but may be in a linear or nonlinear reaction to the concentration of the analyte C and the thickness of the reagent X in several varied situations. Hence, the relations are defined as the functions f(C) and f(X).

For a meter includes two electrodes, the meter 18 provides a constant voltage E, which is not equal to the actual working voltage V, wherein the actual working voltage V is varied corresponding to the transmitted signal.

V=E−I×R

wherein V is the actual working voltage;

E is the constant voltage of the meter;

I is the value of the measuring current;

R is the total impedance value between the electrode and the lead wire; and

I×R is the dropping voltage of the transmitted signal.

According to the above equations and descriptions, the measuring current in the meter is influenced by the main factor, the chemical reaction. However, the structural features of the electrode are also important factors influencing the measuring result, the structures are as the followings:

1. The measuring current is linear proportion to the surface area A of the working electrode, so a stable surface area is a key factor for a good reproducibility.

2. A low total electrode impedance R to reduce the influence of the transmission voltage drop from the measuring current.

3. A conductive electrode material has no chemical interference.

4. Certainly, A uniform thickness of the reagent is a factor too.

The electrode made of the noble metal has preferred effects to meet the above structure features, but costing a lot. A high cost is a defect for a disposable sensor so some disposable sensor made the electrode by traditional screen-printing a conductive film on a plastic sheet, it has low cost advantage but has certain defects to meet the above structure features. Therefore, the present invention try to rectify those drawbacks by means of increasing the stability of the surface area A of the working electrode and reducing the total impedance value R, also use a low cost electrode material but without chemical interference.

As we known, the standard electrode of the laboratory is very expensive and is abandoned after being used in several times. However the analyte or the chemical reagent will contaminate the surface of the electrode. Sometimes, the surface of the electrode is plated with a complex film, which has to be removed via a polishing tool instead of a simple cleansing. That will cost a lot and waste time. Hence, there is a disposable printing electrode 20 (shown in FIG. 2). The disposable electrode 20 is a flack of a flat plastic substrate 21 having plural conductive films 20, 22, 222, and 23, and an isolating layer 223 by means of screen-printing. The procedure for manufacturing this electrode is quite easy, the shape of the electrode could be varied easily, and the cost of it is low. Hence, it is used popularly. Because of the low cost, it is disposable and won't introduce the problems of pollution and cleansing. The pattern of the electrode is easy to be designed, too. This disposable electrode has been popularly applied to be an electrochemical sensor for examining the blood glucose, the uric acid and the cholesterol.

Please refer FIG. 2 and FIG. 3. They illustrate a structure of an electrochemical sensor according to the U.S. Pat. No. 5,985,116. The electrochemical sensor is a disposable sensor and includes a working electrode 22 and a counter electrode 23, which are isolated with each other. The conductive film 20 has one end 221 to be the working electrode 22 and another end 222 to be an output terminal of the working electrode 22 and connect to a meter. In FIG. 3, the isolating layer 223 disposed on the conductive film 20 covers all surface area except of that of the electrodes 22, 23 and the output terminal 222. The isolating layer 30 isolates the conductive film 20 except the electrodes to contact with fluid sample. The isolating layer 30 further includes a spacer 31 for flowing therethrough the fluid sample and a cover 32 for forming a capillarity channel in the measuring section.

With respect to the conductive paste for the conductive film, it can be made by a conductive metal powder (i.e. the gold, the palladium, the silver, the copper, the nickel, and so on) or a carbon-including conductive materials (i.e. the carbon black, the graphite powder, and so on), which is mixed in a solvent, an ore-oil, or a resin to form the conductive paste for being printed in the isolating piece. If the electrode printed by the metal conductive paste, it will have a low impedance value. However, most of the working electrodes with the low-cost metal conductive paste will introduce a chemical interference and can't be used. For example, the silver film electrode will interfere with the glucose oxidase and can't be applied to be a working electrode of a sensor for examining the blood glucose, but it can serve for the counter electrode and the reference electrode in a glucose sensor. Therefore, some noble metals (i.e. a gold, a platinum, a palladium, and a rhodium) have to be introduced or the low-cost conductive carbon film is used to be substitute for a working electrode. The noble metal and the carbon won't introduce the chemical interference, but the noble metal costs a lot, and the conductive carbon film will induce the voltage-dropping problem due to high impedance R and cause an error of the measuring signal. Both of them have drawbacks.

Some person provides an electrode for rectifying those drawbacks. That electrode is produced by means of printing a low-cost metal film (i.e. the silver paste) on a flat plastic piece for obtaining a low impedance and then covering a conductive carbon film for preventing from the chemical interference. The method for manufacturing that electrode is disclosed by U.S. Pat. No. 6,458,258. In the actual practice, when the carbon film covers over the conductive metal film, there should be a lot of air holes exposing parts of the conductive metal film without the carbon film covered. Meanwhile the air holes will induce the metal paste to contact with the fluid sample and cause the chemical interference. In U.S. Pat. No. 5,437,999, it discloses a different disposable electrode, which is produced by means of depositing a noble metal film on an isolating substrate via a physical deposition process and adhering a substrate to be the working electrode for the chemical reaction, but it will cost a lot.

Therefore, it is tried to rectify those drawbacks and provide a method for manufacturing an electrochemical sensor and structure thereof by the present applicant. This invention is an electrochemical sensor for solving the above problems and increasing the reproducibility thereof.

### SUMMARY OF THE INVENTION

It is an object of the present invention to provide a method for manufacturing an electrochemical sensor for solving the above problems and increasing the reproducibility thereof.

According to the present invention, the method for manufacturing an electrochemical sensor, includes steps of (a) providing an injection-molding device, (b) providing an isolating substrate having at least a first recess and at least a first through hole, (c) positing the isolating substrate in the injection-molding device, (d) injecting a conductive plastic material into the injection-molding device for forming an electrode set having a conductive strip disposed in the first recess and including an output terminal and a testing electrode disposed in the first through hole, (e) providing a chemical reagent, and (f) positing the chemical reagent on the testing electrode for testing an analyte in a sample.

Certainly, the sample can be a fluid solution and the chemical reagent tests the analyte and produce an electric measuring signal to be outputted via the testing electrode, wherein the electric measuring signal has a proportion with a concentration of the analyte.

Certainly, the testing electrode can be further electrically connected to an electronic meter.

Certainly, the conductive plastic material can be a resin mixed with at least one of a conductive carbon and a metal powder.

Certainly, the resin can be at least one of a thermosetting resin and a thermoplastic resin.

Certainly, the resin can be an epoxy resin.

Certainly, the conductive carbon can be at least one selected from a group consisting of a carbon black, a graphite power, a carbon fiber and a carbon nanotube.

Certainly, the metal powder can be one selected from a group consisting of a gold powder, a platinum powder, a palladium powder, and a rhodium powder.

Certainly, the conductive carbon can be of a weight density ranged from 3% to 80% in the conductive plastic material.

Certainly, the metal powder can be of a weight density ranged from 0.1% to 5% in the conductive plastic material.

Preferably, the step (d) further includes an antecedent step of mixing the resin with at least one of the conductive carbon and the metal powder for forming the conductive plastic material.

It is another object of the present invention to provide an electrochemical sensor for solving the prior problems and increasing the reproducibility thereof.

According to the present invention, the electrochemical sensor includes an isolating substrate having at least a first recess and at least a first through hole, an electrode set having a first conductive strip disposed in the first recess and having an output terminal and a first testing electrode disposed in the first through hole, and a chemical reagent disposed on the first testing electrode for testing an analyte in a sample solution and producing a electric measuring signal to be outputted via the first testing electrode.

Preferably, the electrochemical sensor further includes an isolating layer on the first conductive strip for isolating the first conductive strip.

Preferably, the first testing electrode serves as a working electrode, the isolating substrate further includes a second recess and a second through hole, the electrode set further includes a second conductive strip disposed in the second recess and having a second output terminal and a second testing electrode disposed in the second through hole, and the second testing electrode serves as a counter electrode.

Preferably, the isolating substrate further includes a third recess and a third through hole, and the electrode set further includes a third conductive strip disposed in the third recess and having a third output terminal and a third testing electrode disposed in the third through hole, wherein the third electrode has an Ag/AgCl film disposed on a surface thereof to serves as a reference electrode.

Preferably, the isolating substrate further includes a flowing recess and a fluid inlet being of a unity with the first through hole.

Preferably, the electrochemical sensor further includes a cover layer disposed on the isolating substrate for forming a capillary channel and a measuring section on the flowing recess and the fluid inlet.

Preferably, the isolating substrate further includes a protruding spacer for urging against the cover layer and isolating the fluid sample and an adhesive of the cover layer.

Certainly, the cover layer can be a plastic plate having a first printing conductive metal film that having a second output terminal and a second electrode terminal to serve as a counter electrode.

Preferably, the cover layer further includes a second printing conductive metal film that having a third output terminal and a third electrode terminal to serve as a reference electrode.

Preferably, the electrochemical sensor further includes a fourth testing electrode to be a detecting electrode to test a flow amount of the sample.

Certainly, the cover layer can be one of a transparent layer and a translucent layer, have an opaque part and be shown a direction facilitating a user to observe how the sample flows.

Certainly, the cover layer can be one of a textile cloth and a plastic mesh and have a mesh count from 20 to 150 per cm.

Preferably, the measuring section and the cover layer further include an inner side produced by means of a hydrophilic coating for facilitating the sample to fill up the measuring section.

Preferably, the flowing recess further includes a placing recess for disposing the chemical reagent.

Preferably, a bottom of the measuring section and a top of the first testing electrode have a height difference, and the placing recess and the testing electrode top form a combination base for being coated with the chemical reagent.

Certainly, the chemical reagent can be injected in a specific amount into the placing recess for forming an equal thickness.

Preferably, the electrochemical sensor further includes a placing recess for disposing a meshed window.

Certainly, the electrode set and the chemical reagent can be disposed in the placing recess to form the measuring section for the sample.

Preferably, the electrochemical sensor further includes a cover layer disposed on the mashed window and connected with the isolating substrate, wherein the cover layer includes an opening for exposing a part of the meshed window.

Preferably, the cover layer is one of a textile cloth and a plastic mesh and has a mesh count from 20 to 150 per cm.

Preferably, the measuring section and the cover layer further include an inner side produced by means of a hydrophilic coating for facilitating the sample to fill up the measuring section.

Preferably, the isolating substrate further includes an inlet for the sample being a fluid to be flowed therein and an air opening for facilitating a capillarity of the fluid sample.

Preferably, the first through hole and the first testing electrode respectively include a through-hole cross-section and a testing-electrode cross-section of the same area.

Certainly, the first through hole can be disposed on a top of the isolating substrate.

Certainly, the first conductive strip can be disposed on a bottom of the isolating substrate and have the first testing electrode disposed on a top of the isolating substrate via the first through hole, wherein the first testing electrode serves as a working electrode.

Preferably, the electrochemical sensor further includes a first printing conductive metal film is printed on a top side of the isolating substrate, and the first printing conductive metal film having a second output terminal and a second electrode terminal for forming a second testing electrode, and the second testing electrode to serve as a counter electrode.

Preferably, the electrochemical sensor further includes a second printing conductive metal film for forming a third output terminal and a third testing electrode.

Preferably, the third testing electrode further includes an Ag/AgCl film to serve as a reference electrode.

Certainly, the isolating substrate can be one selected from a group consisting of a polyvinyl chloride, a polypropylene, a polycarbonate, a polybutylene terephthalate, a polyethylene terephthalate, a modified polyphenylene oxide and an acrylonitrile butadiene styrene.

Certainly, the first conductive strip can be made by means of molding via a conductive-strip molding device including the isolating substrate.

Certainly, the isolating substrate can be made by means of molding via an isolating-substrate molding device including the first conductive strip.

Certainly, the first conductive strip and the isolating substrate can be made in a double-injection-molding process.

Certainly, the first conductive strip can be adhered to the isolating substrate via an adhesive.

Preferably, the first conductive strip further includes a lead for electrically connecting the output terminal and the first testing electrode.

Preferably, the first testing electrode has a thickness ranged from 0.3 mm to 3 mm.

Preferably, the lead has a thickness ranged from 0.28 mm to 2.8 mm.

According to the present invention, the electrochemical sensor could include an isolating substrate having a recess, a first conductive device disposed in the recess and having an output terminal and a first testing electrode, and a chemical reagent disposed on the first testing electrode for testing an analyte in a sample solution and producing an electric measuring signal to be outputted via the first testing electrode.

Certainly, the first conductive device can be a first conductive strip, and the recess further includes a first recess for disposing the first conductive strip therein and a first through hole for disposing the first testing electrode therein.

Preferably, the electrochemical sensor further includes a printing metal film having a printing output terminal and a connecting terminal, wherein the first conductive device is a first conductive pad, the recess further includes a first through hole, and the printing metal film is printed on the isolating substrate and the connecting terminal electrically connects to the output terminal of the conductive pad for receiving the measuring signal from the first testing electrode

Preferably, the first through hole connects with an extended recess for disposing therein an extended base of the first conductive pad.

According to the present invention, an electrochemical sensor includes a conductive set having a first conductive device having a first testing electrode, an isolating substrate having at least a first recess for disposing the first testing electrode, a first printing metal film printed on the isolating substrate and having an output terminal and a connecting terminal connected with the first conductive device, and a chemical reagent disposed on the first testing electrode for testing an analyte in a sample and producing an electric measuring signal to be outputted via the first testing electrode.

Preferably, the isolating substrate further includes a second recess for disposing a second conductive device of the conductive set.

Preferably, the electrochemical sensor further includes a second printing metal film that having a second output terminal and a second connecting terminal connected with the second conductive device.

Preferably, the first testing electrode serves as a working electrode and the second conductive device further serves as a counter electrode.

Preferably, the isolating substrate further includes a third recess for disposing a third conductive device of the conductive set.

Preferably, the electrochemical sensor further includes a third printing metal film that having a third output terminal and a third connecting terminal for connecting the third conductive device.

Preferably, the third conductive device further includes an Ag/AgCl film to serve as a reference electrode.

Certainly, the first printing metal film, the second printing metal film and third printing metal film can be printed on the isolating substrate and a back side of the working area.

Certainly, the first testing electrode can be a working electrode having a working area on a top side of the isolating substrate.

Certainly, the first recess can be a U-shaped recess, and the first conductive device can be a U-shaped conductive device and have an end serving as the first testing electrode and another end serving as a connecting terminal connected with the first conductive metal film for outputting the electric measuring signal of the first testing electrode.

Certainly, the first printing metal film and a working area of the first testing electrode can be disposed on the same side.

Preferably, the electrochemical sensor further includes a second printing metal film having a output terminal and a electrode terminal that printed on the isolating substrate to serve as a second testing electrode and second output terminal.

Preferably, the electrochemical sensor further includes an isolating layer for covering the first printing metal film and the second printing metal film.

Preferably, the isolating layer further includes an inlet for flowing therethrough the sample being a fluid and a C-shaped opening for forming a measuring section.

Preferably, the electrochemical sensor further includes a covering layer and an air hole for forming a capillarity channel in the measuring section.

Preferably, the electrochemical sensor further includes a third printing metal film having a output terminal and a electrode terminal that is printed on the isolating substrate to serve as a third testing electrode and third output terminal, wherein the third testing electrode further includes a Ag/AgCl film to serve as a reference electrode.

It is other object of the present invention to provide an electrode for solving the drawbacks, increasing the reproducibility, and improving its quality.

According to the present invention, the electrochemical sensor includes a conductive piece having an outputting terminal and a first testing electrode, an isolating substrate connected to the conductive piece and having a through hole for disposed the first testing electrode, and a chemical reagent disposing on the first testing electrode for testing a sample solution and producing an electric measuring signal to be outputted via the first testing electrode.

Certainly, the first testing electrode can be a protruding part of the conductive piece for being disposed in the through hole of the isolating substrate.

Preferably, the isolating substrate further includes a first printing metal film to be a second testing electrode and a second output terminal.

Preferably, the isolating substrate further includes a second printing metal film to be a third testing electrode and a third output terminal.

Preferably, the third testing electrode further includes an Ag/AgCl surface to be a reference electrode.

Certainly, the first testing electrode, the second testing electrode and the third testing electrode can be a working electrode, a counter electrode and a reference electrode respectively.

According to the present invention, an electrochemical sensor could includes a conductive sheet made by plastic-injection process and having an outputting terminal and a first testing electrode, an isolating layer connected to the conductive sheet and having a through hole for exposing a surface area of the first testing electrode meanwhile making a placing recess on a top of the first testing electrode, and a chemical reagent disposing on the placing recess for testing an analyte in a sample solution and producing an electric measuring signal to be outputted via the first testing electrode.

Preferably, a top of the isolating layer and a top of the first testing electrode have a height difference to form the placing recess, meanwhile the chemical reagent is injected in a specific amount into the placing recess for forming an equal thickness.

Preferably, the first testing electrode serves as a working electrode, and wherein the isolating layer further includes a first printing metal film to be a second testing electrode and a second output terminal.

Preferably, the second testing electrode serves as a counter electrode, and the isolating layer further includes a second printing metal film to be a third testing electrode and a third output terminal, meanwhile the third testing electrode further includes an Ag/AgCl surface to be a reference electrode.

According to the present invention, the electrochemical electrode includes a conductive strip having an outputting terminal and a first testing electrode, and an isolating substrate connected to the conductive strip and having a through hole for disposed the first testing electrode.

Preferably, the electrochemical sensor further includes a reagent matrix layer on a surface of the first testing electrode to modify the first testing electrode to be the working electrode.

Preferably, the reagent matrix layer includes at least one of an enzyme, a PH buffer, a surfactant, a redox mediator, and a hydrophilic polymer compound.

Certainly, the enzyme can be a glucose oxidase for testing a concentration of a blood glucose in a blood.

Certainly, the enzyme can be an uricase for testing a concentration of a uric acid in a blood.

Certainly, the enzyme can be a cholesterol esterase and a cholesterol oxidase for testing a concentration of cholesterol in a blood.

Preferably, the first testing electrode serves as a counter electrode.

Preferably, the electrode further includes a Ag/AgCl layer on a surface of the first testing electrode to modify the first testing electrode to be a Ag/AgCl modified reference electrode.

Now the foregoing and other features and advantages of the present invention will be more clearly understood through the following descriptions with reference to the drawings, wherein:

### BRIEF DESCRIPTION OF THE DRAWINGS

FIG. 1 illustrates an electrochemical sensor basic equipment according to the prior art;

FIG. 2 illustrates a disposable electrochemical sensor according to the prior art;

FIG. 3 illustrates a decomposed structure of FIG. 2;

FIG. 4 illustrates a decomposed of the preferred embodiment of the electrochemical sensor according to the present invention;

FIG. 5 illustrates a decomposed structure of a testing electrode of FIG. 4;

FIG. 6 illustrates a stereopicture of a modified electrode that is modified from the testing electrode of FIG. 4.

FIG. 7 illustrates a combination of the electrochemical sensor of FIG. 4 and FIG. 6.

FIGS. 8(a)-(b) illustrate another preferred embodiment of an electrochemical sensor according to the present invention;

FIG. 9(a) illustrates a decomposed structure of the electrochemical sensor of FIG. 8;

FIG. 9(b) illustrates the conductive cross-section of the electrode and the thickness thereof;

FIG. 10 illustrates an electrochemical sensor having three electrodes according to the present invention;

FIGS. 11(a)-(c) illustrate an electrochemical sensor having four electrodes according to the present invention;

FIG. 12(a) illustrates another preferred embodiment of an electrochemical sensor having three electrodes according to the present invention;

FIG. 12(b) illustrates the electrochemical sensor of FIG. 12(a) disposed in a container;

FIGS. 13(a)-(b) illustrate other preferred embodiment of a electrochemical sensor having three electrodes according to the present invention;

FIG. 14(a) illustrates a decomposed structure of a electrochemical sensor having two electrodes according to the present invention;

FIG. 14(b) illustrates a decomposed structure of a electrochemical sensor having three electrodes according to the present invention;

FIG. 15 illustrates the electrochemical sensor inserted into a meter according to the present invention;

FIG. 16 illustrates an electrochemical sensor having single electrode according to the present invention;

FIG. 17 illustrates the decomposed structure of the electrochemical sensor of FIG. 16;

FIG. 18 illustrates other preferred embodiment of an electrochemical sensor having two electrodes according to the present invention;

FIGS. 19(a)-(d) illustrate other electrochemical sensor having three electrodes according to the present invention;

FIGS. 20(a)-(b) illustrate other preferred embodiment of an electrochemical sensor having three electrodes according to the present invention; and

FIG. 20(c) illustrates a decomposed structure of other electrochemical sensor having three electrodes according to the present invention.

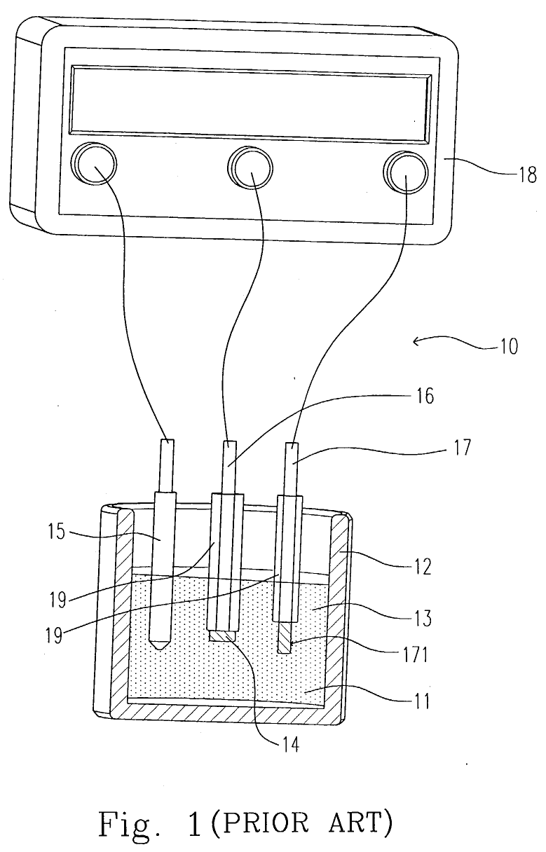

### DETAILED DESCRIPTION OF THE PREFERRED EMBODIMENT

The main purpose of the present invention is to provide a method for manufacturing an electrochemical sensor for solving the drawbacks, increasing the reproducibility, and improving its quality.

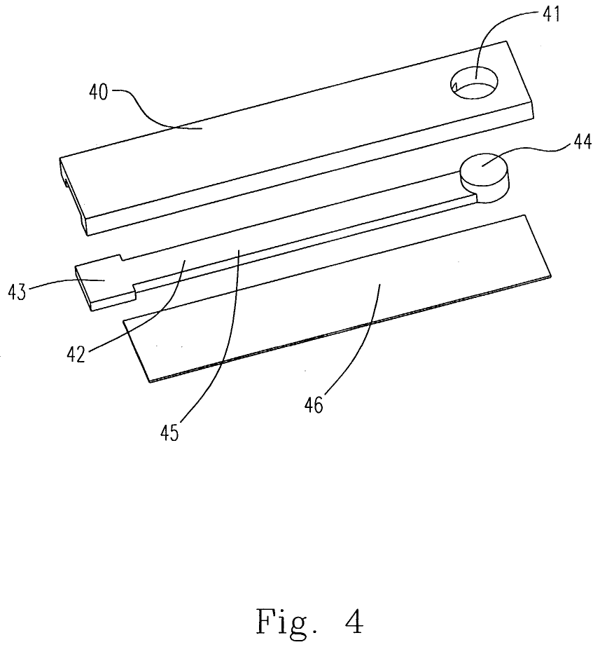

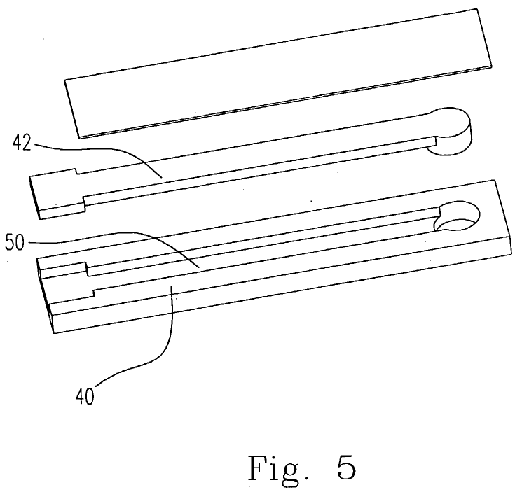

Please refer to FIGS. 4-6. They illustrate an electrochemical sensor manufactured by the method of the present invention. The method for manufacturing the electrochemical sensor includes steps of (a) providing an injection-molding device (the device does not show in the figures), (b) providing an isolating substrate 40 having a first recess 50 and a first through hole 41, (c) positing the isolating substrate 40 in the injection-molding device, (d) injecting a conductive plastic material into the injection-molding device for forming a conductive strip 42 disposed in the first recess 50 and including an output terminal 43 and a testing electrode 44 disposed in the first through hole 41, (e) providing a chemical reagent 60, and (f) positing the chemical reagent 60 on the testing electrode 44 for testing an analyte in a sample. Meanwhile, the sample is a fluid and the chemical reagent 60 tests the analyte and produces a measuring electric signal to be outputted via the testing electrode 44.

The testing electrode 44 of the present invention is electrically connected to an electronic meter. The conductive plastic material is a resin mixed with at least one of a conductive carbon and a metal powder, wherein the resin could be a thermosetting resin or a thermoplastic resin; the conductive carbon could be one selected from a group consisting of a carbon black, a graphite power, a carbon fiber and a carbon nanotube; and the metal powder could be one selected from a group consisting of a gold powder, a platinum powder, a palladium powder, and a rhodium powder. Furthermore, the conductive carbon could be of a weight density ranged from 3% to 80% in the conductive plastic material, and the metal powder can be of a weight density ranged from 0.1% to 5% in the conductive plastic material. The resin is mixed with at least one of the conductive carbon and the metal powder for forming the conductive plastic material, which is a fluid. Then it is injected into the first recess 50 and the first through hole 41 of the isolating substrate 40 for forming a first conductive strip 42 connected closely with the isolating substrate 40.

The present invention also provides an electrochemical sensor, which includes an isolating substrate 40 having a first recess 50 and a first through hole 41, a first conductive strip 42 disposed in the first recess 50 and having an output terminal 43 and a first testing electrode 44 disposed in the first through hole 41, and a chemical reagent 60 disposed on the first testing electrode 44 for testing a sample and producing a measuring signal to be outputted via the first testing electrode 44.

Please refer to FIG. 4, the surface area 44 of the first testing electrode is made by an injection molding device which is a steel tool, the tools dimension will be fixed after completed it, the reproducibility (the dimension stability between the different injection cavity of the plastic tool and different production lot) of the surface area 44 dependent on the sum of two factors, one is the tooling dimensions tolerance between the multi-cavity of the injection steel tools, another factor is the change ratio of the plastic shrinkage between different production lot. In the modern technical, to control the dimension of a plastic injection tool under a 0.3% tolerance is a general skill. Further, if a plastic material is selected properly, the change ratio of a plastic parts dimension will be below 0.3% easily, for example, the total shrinkage of a ABS, a PC and a PBT plastic materials are all below 0.5%(shrinkage is difference between the dimension of the injection tool and the real plastic part after injection), and the change ratio is just the shrinkage difference between the different production lot or injection cavity, for example, one pieces has 0.45% shrinkage and another is 0.38% then the change ratio is 0.07% only.

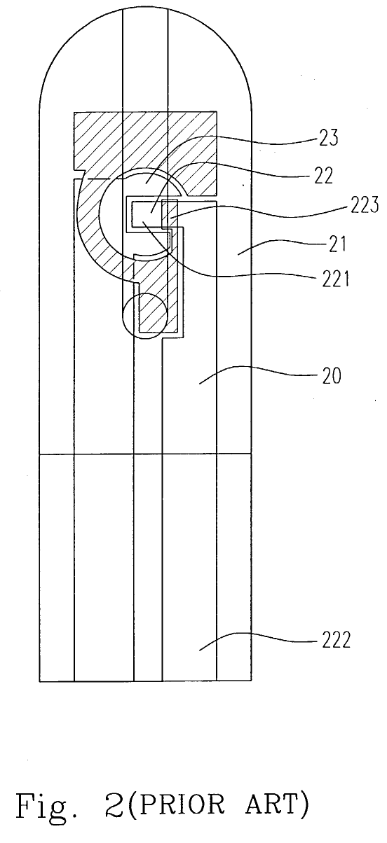

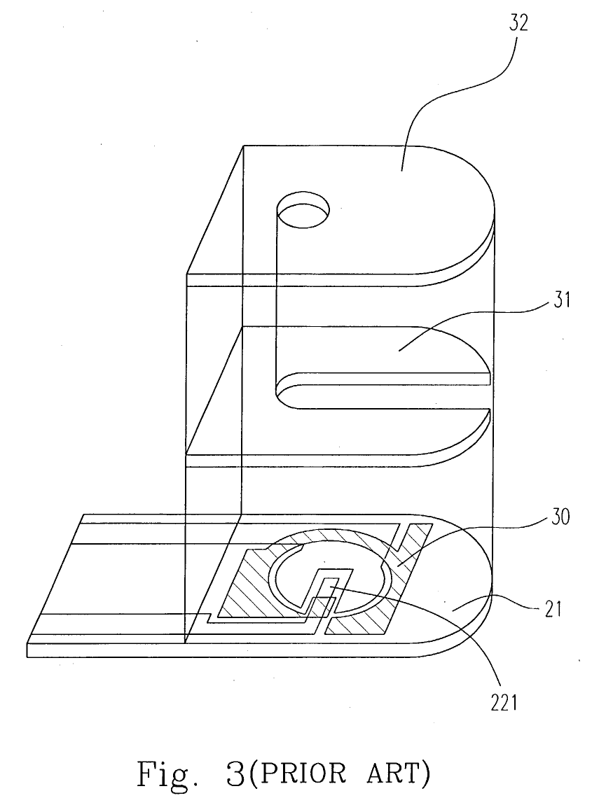

Totally the present invention can easily control the surface area of a testing electrode under 0.6% change tolerance, and it is very lower than the electrode made by traditional screen-printing conductive film. The traditional screen-printing tool is a soft glue-film and easy to change dimension thereof, so the conductive film size is unstable. Although some electrode of a disposable sensor is made by means of a thick-film process, it can get a more stable dimension of conductive film than the traditional screen-printing type does, but both two type has the same problem that the actual effective surface area of a working electrode is not decided by the dimension of the conductive film only. It is also changed by a printing insulating layer. Please refer to the FIG. 2, which is a prior disposable sensor by screen-printing. The working electrode 22 needs a lead 20 to connect electrically to the output terminal 222 to output the measuring signal. Meanwhile, the lead 20 is on the same side of the working electrode 22, so it needs to print an insulating layer 223 to isolate the lead. The actual surface area 221 of the working electrode can not decided by the conductive film 22 only, and the position movement and dimension change of the insulating layer 223 will effect it. In the present invention, please refer to the FIG. 4, the lead 45 of the working electrode is disconnected with the surface area 44 of the working electrode, so the actual surface area decided by the dimension of electrode 44 only. The measuring signal of an electrochemical sensor is linear proportion to the surface area of the working electrode, so the present invention can increase the reproducibility of the measurement.

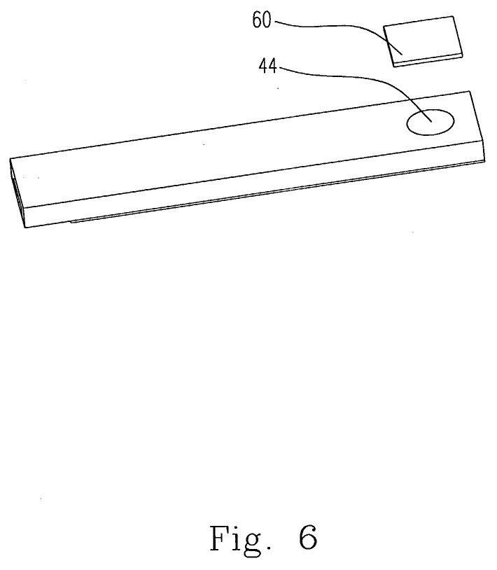

Please refer to FIG. 6. It illustrates a “Modified Electrode” which is made from the embodiment as FIGS. 4-5 and the testing electrode is modified by means of positing a chemical reagent on the surface area of the testing electrode, wherein the reagent includes a specific enzyme and their compounds, and it is so call “Modified Enzyme Working Electrode”. Meanwhile the chemical reagent can be instead of an Ag/AgCl film to modify the testing electrode to a “Modified Ag/AgCl Reference Electrode”.

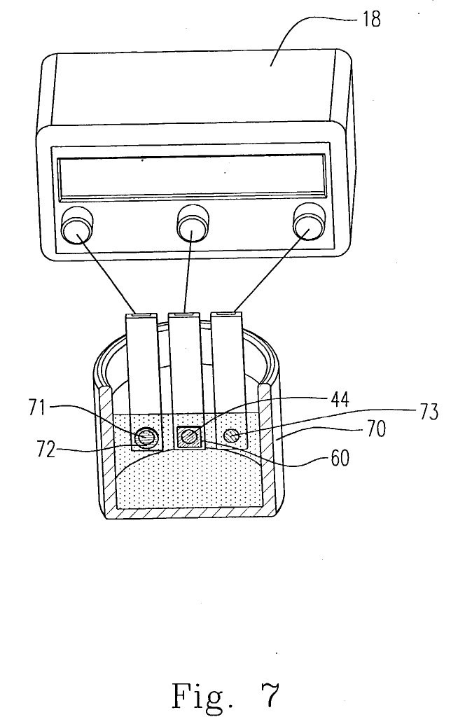

Please refer to FIG. 7. It combines a “Modified Enzyme Working Electrode” 60, a “Modified Ag/AgCl Reference Electrode” 72 and a “Counter Electrode” 73, but without any modification to a set of electrochemical sensor.

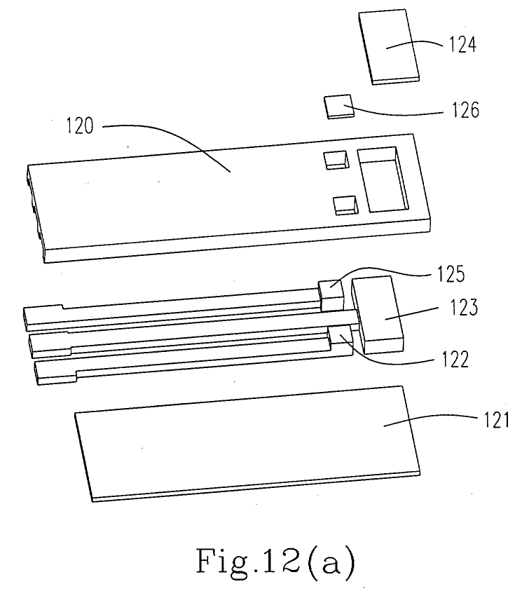

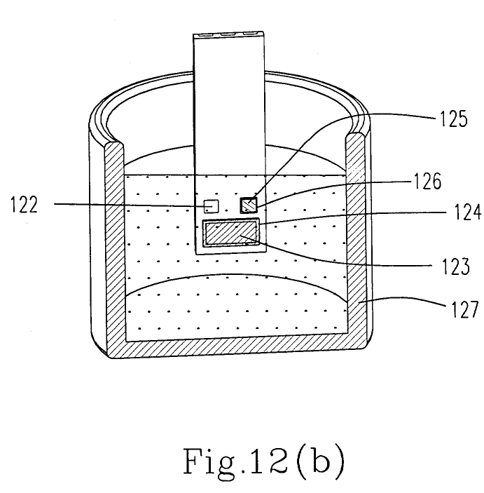

Please refer to FIGS. 12(a)-(b). It merges 3 separated testing electros that shown FIG. 7 to one isolating substrate 120.

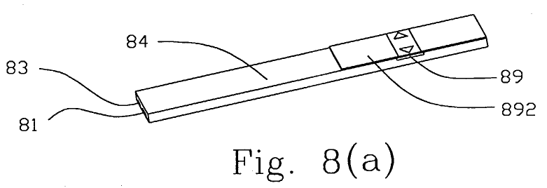

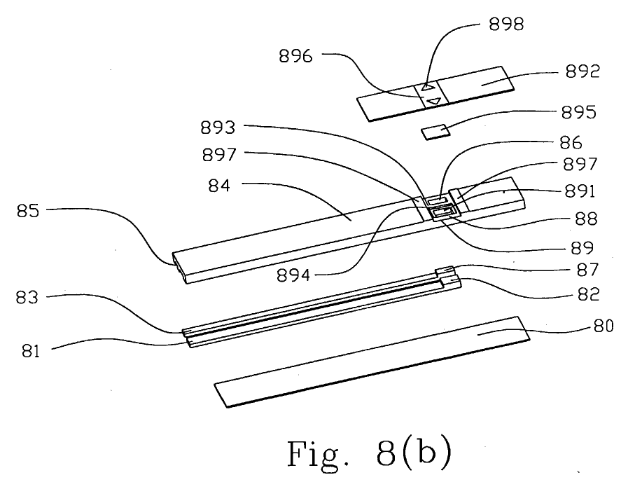

The embodiments of FIG. 4-7 and FIG. 12 are used for testing a much volume of sample fluid that can't suit to test a little volume sample. It needs to make a small testing chamber to absorb the little sample. Please refer to FIG. 8(b). It illustrates another preferred embodiment according to the present invention to make a small testing chamber for testing small volume sample. The electrochemical sensor further includes an isolating layer 80 on the first conductive strip 81 for isolating the first conductive strip 81, wherein the first conductive strip 81 serves for a working electrode. Furthermore, the electrochemical sensor includes a second conductive strip 83. The isolating substrate 84 includes a second recess 85 and a second through hole 86 for respectively disposing the second conductive strip 83 and a second testing electrode 87 therein, wherein the second testing electrode 87 serves for a counter electrode.

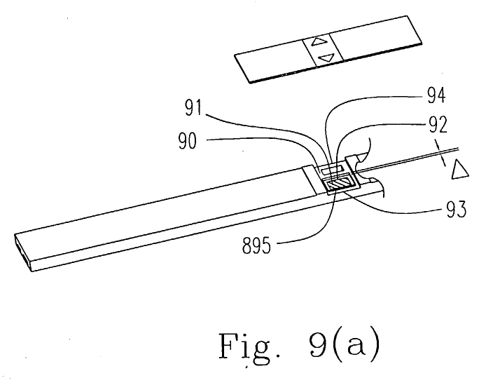

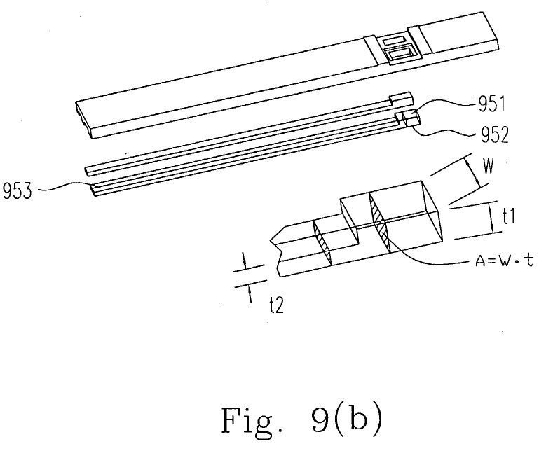

Referring to FIGS. 8(a)-(b), we can find that the isolating substrate 84 further includes a flowing recess 88 and a fluid inlet 89 being of a unity with the first through hole 891 and the second through hole 86. The flowing recess 88 further includes a placing recess 894 for disposing the chemical reagent 895. The electrochemical sensor further includes a cover layer 892 disposed on the isolating substrate 84 for forming a capillary channel and a measuring section 893 on the flowing recess 88 and the fluid inlet 89. Meanwhile the cover. layer 892 can be one of a transparent layer and a translucent layer, and a bottom 90 (Referring to FIG. 9(a)) of the measuring section 893 and a top 91 of the first testing electrode 82 have a height difference A, and the placing recess 894 and the testing electrode top 91 form a combination base 92 for being placed with the chemical reagent 895. The chemical reagent 895, which is a fluid, can be injected to the placing recess 894 in a specific amount for forming a uniform thickness on the combination base 92.

Please refer to FIG. 8(b) again. It illustrates a cover layer 892 having a window 896 for facilitating a user to observe how the sample flows. The window 896 further includes a direction mark 898 for reminding the user. The isolating substrate 84 further includes two protruding spacers 897 for urging against the cover layer 892 and isolating the fluid sample and an adhesive on the cover layer 892.

Please refer to FIG. 9(a). The isolating substrate further includes an inlet 93 for the sample being a fluid to be flowed therein and an air opening 94 for facilitating a capillarity channel of the fluid sample and forming a small testing chamber.

Please refer to FIG. 9(b). It illustrates a low impedance of an electrode in present invention. The conductive strip injected by a carbon base conductive plastic material, and the thickness t1 of the electrode 951 can be 0.3 to 3 mm as the design requirement. This thickness is impossible to approach by the tradition screen-printing. Normally the thickness is 2-30 μm only by screen-printing. Those are the conductive films 22, 23, 20, 222 shown in the FIG. 2. The impedance equation of a conductor is as:

Impedance R=ρ×L/A=ρ×L/(W×t),

wherein R: Electrode Total Impedance

ρ: Resistance Coefficient

L: Length from the Electrode to the Output Terminal

A: Cross Section Area of the Electrode and Lead

W: Width of the Electrode and Lead

t: Thickness of the Electrode and Lead

As the description of the above equation, the present invention increases the thickness of the electrode and the lead to reduce the total impedance. In the FIG. 9(b) embodiment, the conductive strip injected by a carbon base conductive plastic material and the electrode strip 951 has a 0.6 mm thickness t1. This thickness is thick several ten times than the traditional screen-printing carbon film, so the impedance is also lower several ten times, and the impedance from the electrode surface area 951 to the output terminal 953 of this embodiment is below 300Ω. In other condition, a tradition screen-printing carbon film is description as the U.S. Pat. No. 5,985,116. That patent discloses that the impedance of a conductive carbon film is less than 10KΩ. Comparing with it, we can find that the present invention has advanced improvement on the electrode impedance by means of using the same low-cost carbon base conductive material. High electrode impedance will make a much more transmission voltage drop after transmitting the measuring current therethrough. This transmission drop will change the actual working voltage and affects the measurement accuracy.

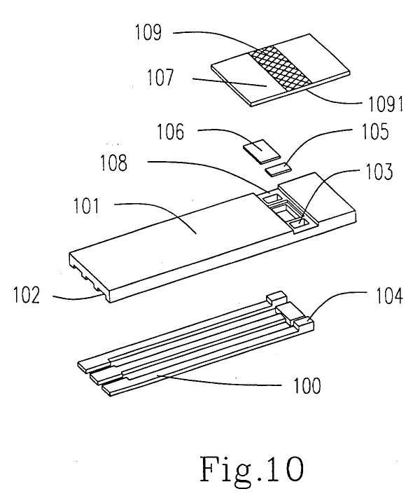

In FIG. 10, the electrochemical sensor further includes a third conductive strip 100, and a third recess 102 and a third through hole 103 disposed on the isolating substrate 101, wherein the third conductive strip 100 and a third testing electrode 104 of the third conductive strip 100 are disposed in the third recess 102 and the third through hole 103 respectively, and the third testing electrode serves for a reference electrode.

Furthermore, the cover layer can be made of one of a textile cloth and a plastic mesh and has plural meshes 109 in a mesh count from 20 to 150 per cm. The measuring recess 108 and the cover layer further include an inner side 1091 produced by means of a hydrophilic coating for facilitating the sample to fill up.

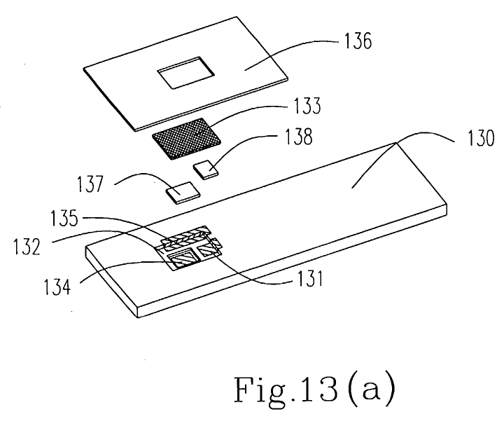

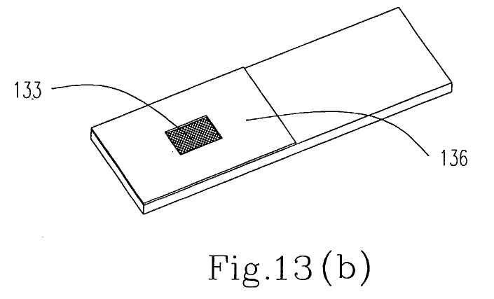

Please refer to FIGS. 6, 7, 8, 10, 11, 12 and 13. The first electrode or the third electrode is further modified via different methods and processes and forms a specific modified electrode with a specific function. For example, the third electrode, which has been treated by the antecedent process, includes an Ag/AgCl film (i.e. 71 of FIG. 7, 105 of FIG. 10, 126 of FIG. 12, 138 of FIG. 13) produced by means of screen-printing or electroplating.

With respect to the first electrode, it is coated a reagent matrix (895 of FIG. 8, 106 of FIG. 10, and 124 of FIG. 12) via the antecedent process and the modified process to be a working electrode (44 of FIG. 7). The reagent matrix reacts with the analyte in a testing sample to execute an electrochemical reaction for transferring the measuring signal to an electric parameter that is proportion to a concentration of a analyte in the testing sample.

The reagent matrix layer includes an enzyme (ex. a glucose oxidase and a uricase), a PH buffer (ex. a citrate buffer), a surfactant (ex. FC-170C of 3M), a redox mediator (ex. a ferricyanide), a hydrophilic polymer compound (ex. a polyethylene oxide, a carboxymethyl cellulose, and a mixture thereof). The reagent matrix could be immobilized and coated on the working electrode according to specific ratios.

Meanwhile, the enzyme can be a glucose oxidase for testing a concentration of a blood glucose in a blood.

Certainly, the enzyme can be an uricase for testing a concentration of a uric acid in a blood.

For another embodiment, the enzyme can be a cholesterol oxidase and cholesterol esterase for testing a concentration of cholesterol in a blood.

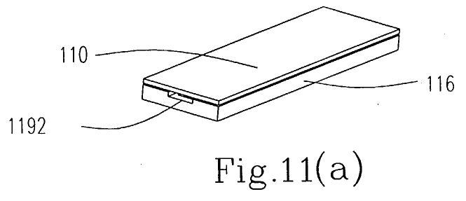

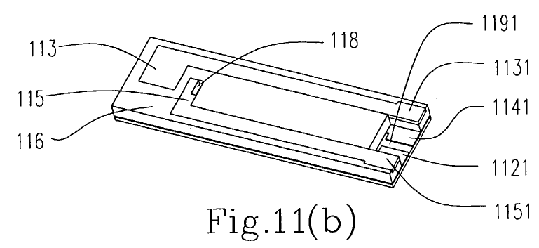

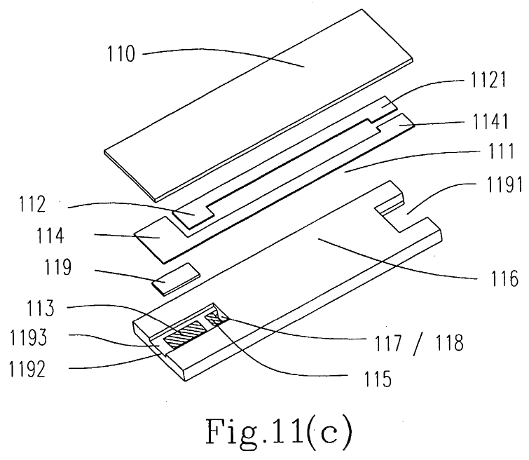

Please refer to FIGS. 11(a)-(c). The cover layer 110 includes a printing conductive metal film 111 produced by means of printing, wherein the printing conductive metal film 111 is divided into two conductive films serving for a reference electrode 112 and a counter electrode 114, and printed on the isolating substrate 110. An air hole 118 and a flow-amount measuring electrode 115 are disposed in the second through hole 117. The air hole 118, the flowing recess 1193 and a fluid inlet 1192 form a capillarity channel. There is a C-shaped opening 1191 for disposing the output terminal 1121, 1141. The fourth testing electrode 115 is a detecting electrode to test a flow-amount of the sample. The fluid sample flows through the fluid inlet 1192, the flowing recess 1193 and the working electrode 113, and achieves the fourth testing electrode 115 for fulfilling the process. While the fluid sample doesn't achieve the fourth testing electrode 115, the meter (150 of FIG. 15) will show that the fluid sample doesn't fill up the channel.

Please refer to FIG. 12(a). The back side of the isolating substrate 120 further includes an isolating film 121 for isolating and protecting the conductive strip except the surface of the electrode and the output terminal thereby the electrochemical sensor being immersed in the fluid sample. FIG. 12(b) illustrates an electrochemical sensor including the chemical reagent 124 of the working electrode, the Ag/AgCl modified electrode of the reference electrode 126 and the counter electrode 122 and immersed in the fluid sample. Please refer to FIG. 13(a). It illustrates another electrochemical sensor having three electrodes. The electrochemical sensor further includes a placing recess 132 for disposing a meshed window 133. Furthermore, the working electrode 134, the counter electrode 135, the reference electrode 131, the chemical reagent 137 and the Ag/AgCl film 138 are disposed on the placing recess 132, and a cover layer 136 is disposed on the meshed window 133 for forming a measuring section in the placing recess 132. In FIG. 13(b), the cover layer 136 further includes an opening to be a flowing inlet, and then the fluid sample is dropped in via the meshed window 133, wherein the meshed window 133 and the placing recess 132 are produced by means of a hydrophilic coating for facilitating the sample to fill up the measuring section.

In FIG. 4, the isolating substrate 40 can be made of one selected from a group consisting of a polyvinyl chloride, a polypropylene, a polycarbonate, a polybutylene terephthalate, a polyethylene terephthalate, a modified polyphenylene oxide and an acrylonitrile butadiene styrene. Moreover, the first conductive strip 42 can be made by means of molding via a conductive-strip molding device including the isolating substrate 40. Certainly, the first conductive strip 42 and the isolating substrate 40 can be made in an injection-molding process with two materials. In other embodiment, the first conductive strip 42 can be adhered to the isolating substrate 40 via an adhesive.

According to other embodiment of the present invention, the electrochemical sensor includes an isolating substrate 40 having a recess (including a first recess 50 and a first through hole 40), a first conductive device 42 disposed in the recess 50 and having an output terminal 43 and a first testing electrode 44, and a chemical reagent 60 disposed on the first testing electrode 44 for testing an analyte in a sample and producing a measuring signal to be outputted via the first testing electrode 44.

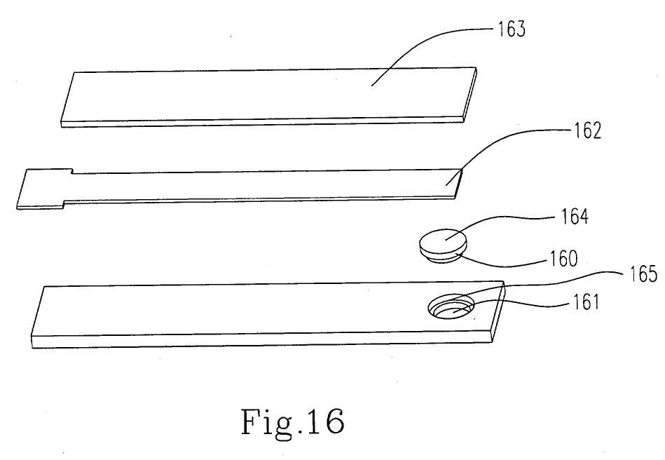

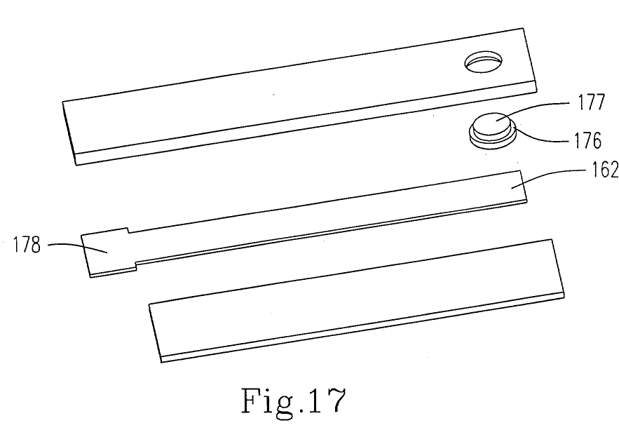

As shown in FIG. 4, the first conductive device can be a first conductive strip 42, and the recess further includes a first recess 50 for disposing the first conductive strip 42 therein and a first through hole 41 for disposing the first testing electrode 44 therein. Please refer to FIGS. 16 and 17. The first conductive device also can be a first conductive pad 160 and the recess further includes a first through hole 161. The surface of the working electrode 177 is disposed on a first surface of the conductive pad 160. The first printing metal 162 is printed on both the isolating substrate and a second surface 164 of the conductive pad 160 and electrically connects to an output terminal 178 for receiving the measuring signal from the first testing electrode 177. The first through hole 161 further connects with an extended recess 165 for disposing therein an extended base 176 of the first conductive pad 160. The printing conductive metal 162 of this embodiment is the lead and the output terminal of the first testing electrode (a working electrode), but it doesn't contact with the surface of the working electrode 177. Therefore, the printing conductive metal won't contact with the fluid sample and won't introduce the chemical interference. The surface of the working electrode 177 won't be influenced by the size of the printing metal, and thereby the measuring signal is stable with any interference. Furthermore, the resistance value of the first conductive strip 42 and the lead wire 45 will decrease.

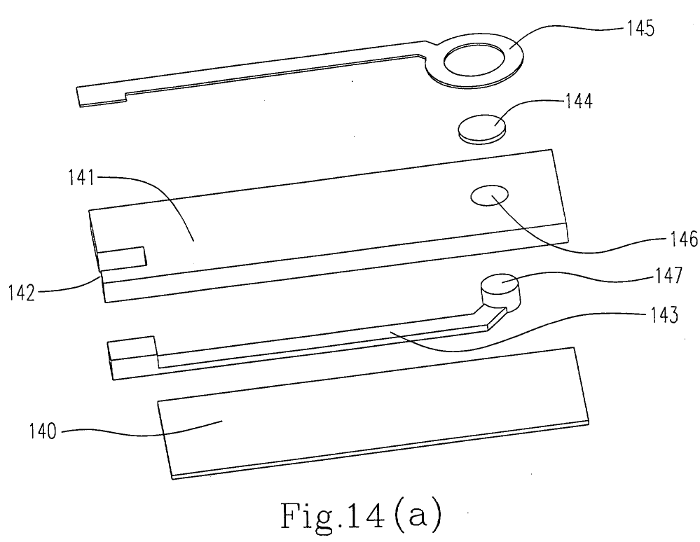

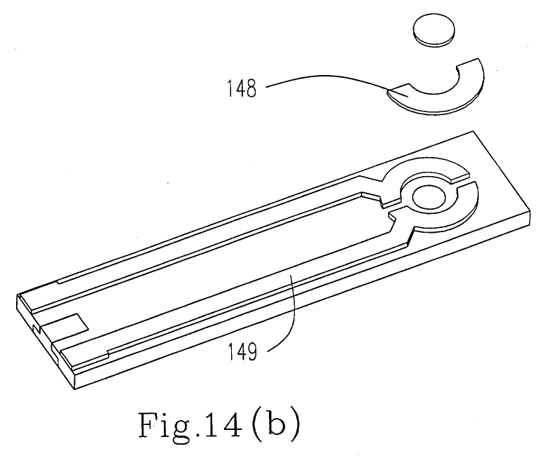

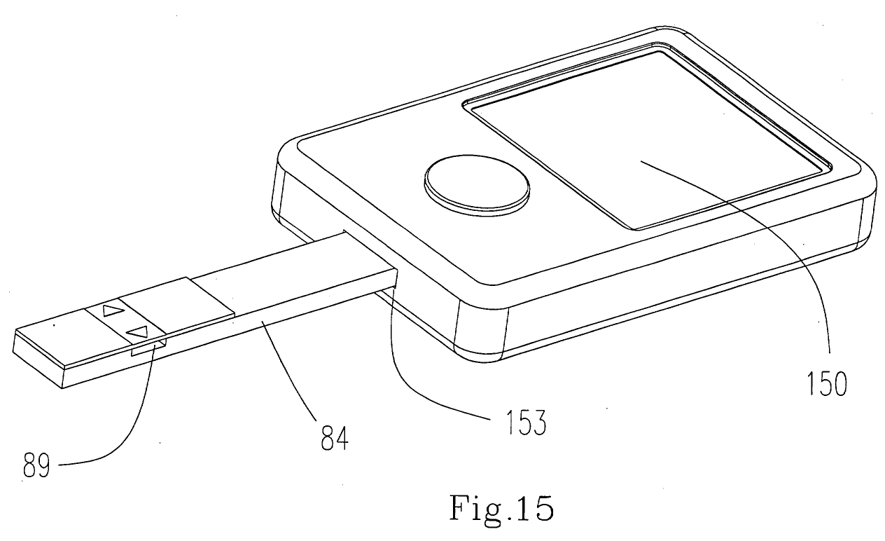

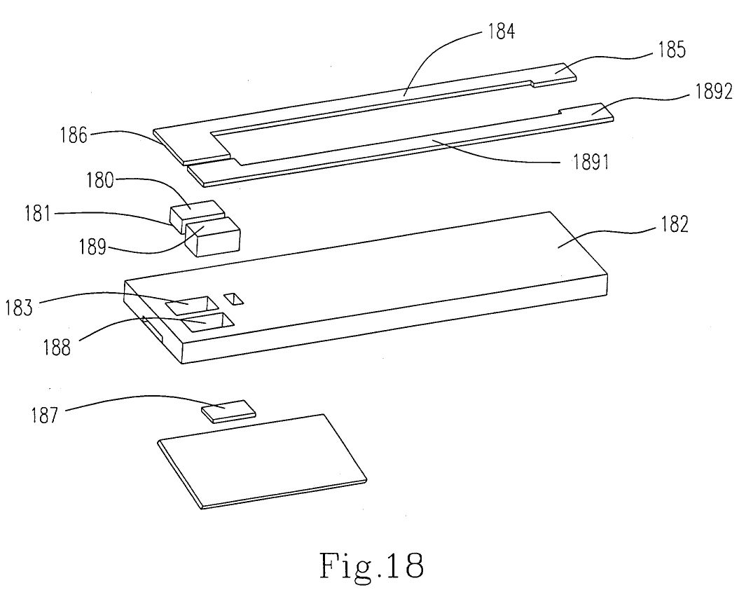

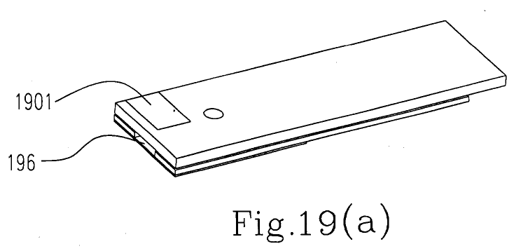

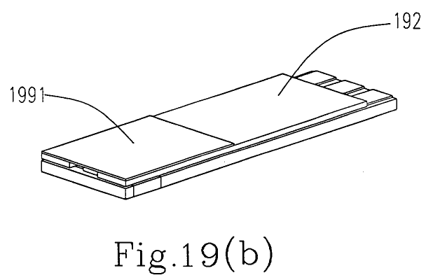

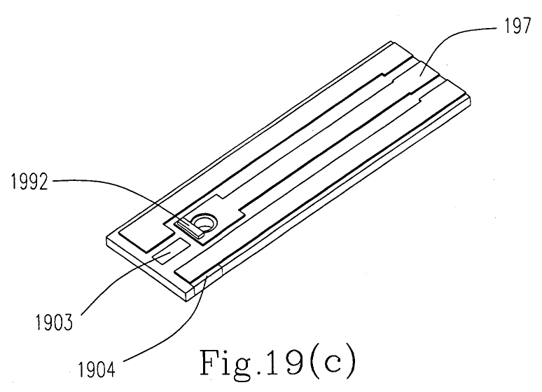

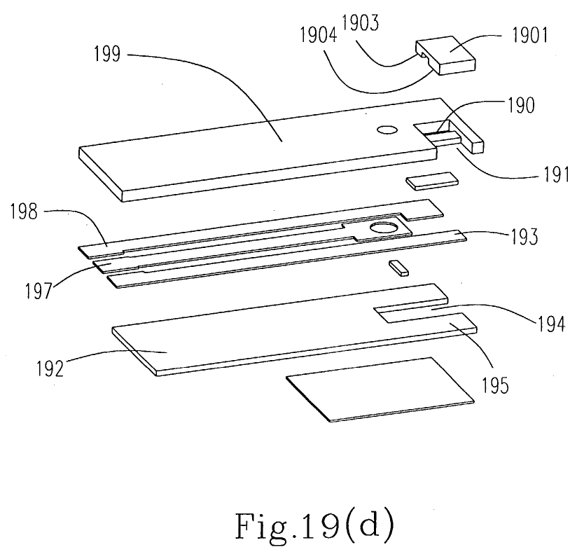

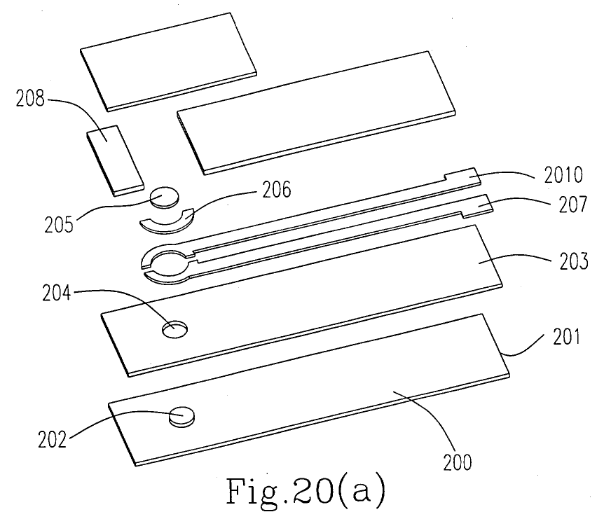

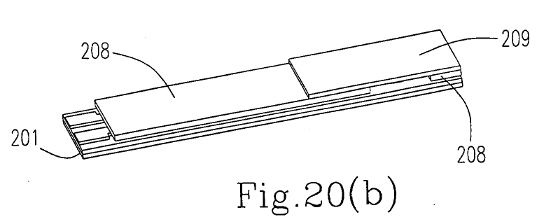

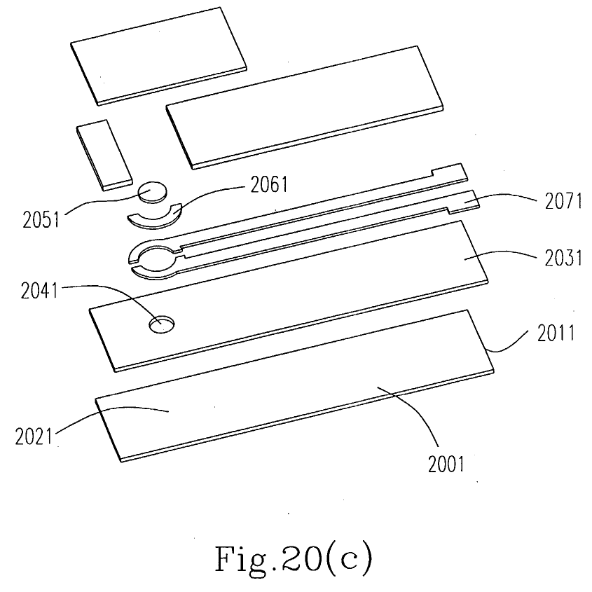

FIG. 9(b) illustrates a first testing electrode 951 made of the carbon-including conductive plastic compound by means of an injection-molding process. The total resistance value from the surface of the testing electrode 951 to the output terminal 953 surface is lower than 300Ω, which is ten times lower than that of the printing conductive carbon film electrode, but several times larger than that of the low-costing printing metal film (ex. the sliver printing film is lower than 10Ω). FIG. 16 illustrates the working area of a working electrode made of the low-costing carbon-base conductive compound by means of an injection-molding process, which has a low resistance value and a stable working electrode surface without any chemical interference. But the lead of a working electrode does not require a stable surface and has no chemical interference problem, so the lead section is printed by a low cost printing metal film to get a total impedance is less than 50Ω that is lower than the 300Ω that described as the FIG. 9(b). Certainly, the other electrodes and lead wires could be made by the low-costing metal printing films for increasing respective benefits. Please refer to FIG. 14 (a). The embodiment of the electrochemical sensor includes two electrodes. The first conductive strip 143 is made by the plastic conductive material. The surface of the working electrode 147 disposed in the first through hole 143 is a stable surface with an error lower than 0.6%. Furthermore, the counter electrode 145 won't introduce the chemical interference and has no stable size problem, wherein the first printing metal film 145 is printed on the isolating substrate 141 for obtaining a lower resistance counter electrode 145 and increasing the accuracy of measuring. FIG. 14(b) illustrates an electrochemical sensor having three electrodes. The second printing metal film 149 and the first printing metal film are printed on the isolating substrate for forming the reference electrode. It further includes an Ag/AgCl modified film 148 for modifying the reference electrode 149 to be an AgCl reference electrode. Similarly, FIG. 18, FIG. 19 and FIG. 20 illustrate other embodiments according to the present invention.

According to the other embodiment of the present invention, FIG. 18 illustrates an electrochemical sensor including a first conductive device 180 having a first testing electrode 181, an isolating substrate 182 having a first recess 183 for disposing the first testing electrode 181, a first printing metal film 184 printed on the isolating substrate 182 and having an output terminal 185 and a connecting terminal 186 connected with the first conductive device 180, and a chemical reagent 187 disposed on the first testing electrode 181 for testing a sample and producing a measuring signal to be outputted via the first testing electrode 181.

The isolating substrate 182 further includes a second recess 188 for disposing a second conductive device 189, and a second printing metal film 1891 for connecting the second conductive device 189 and the isolating substrate 182. The first recess 183 of FIG. 18 can be modified and changed as the first recess 190 of FIG. 19(d). The first recess 190 combine a lateral recess 191 to form a U-shaped recess, and the first conductive device 1901 is a U-shaped conductive device disposed in the first recess 190 and has an end 1903 disposed in the first recess 190 serving as the first testing electrode 1903 and another end 1904 serving as a connecting terminal 1904 for outputting the measuring signal of the first testing electrode 1903. It further includes an isolating layer 192 for covering the first printing metal film 193 and the connecting terminal 1904. In this embodiment, the first printing metal film 193, the second printing metal film 197 and the third printing metal film 198 can be printed on the same surface of the isolating substrate. The isolating layer 192 further includes an inlet 194 for flowing therethrough the sample being a fluid and a C-shaped opening 195 for forming a measuring section 196 (shown in FIG. 19(a). In FIG. 19(b), it illustrates a cover layer 1991 disposed on the isolating layer 192. In FIG. 19(c), it illustrates a modified electrode 1992 disposed on the second printing metal film 197.

According to the other embodiment of the present invention, FIG. 20(a) illustrates another electrochemical sensor including a conductive piece 200 having an outputting terminal 201 and a first testing electrode 202, an isolating substrate 203 connected to the conductive piece 200 and having a through hole 204 for disposed the first testing electrode 202, and a chemical reagent 205 disposing on the first testing electrode 202 for testing a sample and producing a measuring signal to be outputted via the first testing electrode 202.

Meanwhile, the first testing electrode 202 can be a protruding part 202 of the conductive piece 200 for being disposed in the through hole 204 of the isolating substrate 204. The electrochemical sensor further includes a modified electrode 206 disposed on the second printing metal film 207 to be a reference electrode 206. FIG. 20(b) illustrates a cover layer 209 disposed on two isolating layer 208.

According to the other embodiment of the present invention, FIG. 20 (c) illustrates another electrochemical sensor including a conductive sheet 2001 having an outputting terminal 2011 and a first testing electrode 2021, an isolating layer 2031 connected to the conductive sheet 2001 and having a through hole 2041 for exposed a surface area of the first testing electrode 2021, and a chemical reagent 2051 disposing on the first testing electrode 2021 for testing a sample and producing a measuring signal to be outputted via the first testing electrode 2021. The second printing metal film 2071 further includes an AgCl film 2061 disposed thereon and servers for a reference electrode. Moreover, a top of the isolating layer 2031 and a top of the first testing electrode 2021 have a height difference to form a placing recess 2041, meanwhile chemical reagent is injected in a specific amount into the placing recess for forming an equal thickness.

In the embodiments of FIG. 20, the conductive strip is substituted by a conductive sheet for facilitating to be manufactured by means of an injection-molding process The plastic materials are injected to the molding device in a specific pressure for discharging the air and filling up the whole molding device with the injected materials. When the isolating substrate has three sides to surround the conductive strip, a side serving for injecting the materials therethrough, the air of the molding device won't be easy to be discharged and the plastic material cannot fill up completely. The product has drawbacks for lack of stuff. In this embodiment, the conductive sheet and the isolating substrate can contact with the molding device in four sides and the lateral wall of the molding device can provide an air hole for discharging the air from the molding device.

Please refer to FIG. 15. It illustrates an electrochemical sensor 84 of the present invention inserted into a trough 153 of an electrochemical meter 150. While a fluid sample flows into the flowing inlet 89 of the electrochemical sensor 84, the electrochemical meter 150 will show an analyzed result about the fluid sample.

In conclusion, the present invention possesses many outstanding characteristics, effectively improves upon the drawbacks associated with the prior art in practice and application, produces practical and reliable products, bears novelty, and adds to economical utility value.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A method for manufacturing an electrochemical sensor, comprising steps of:
(a) providing an injection-molding device;
(b) providing an isolating substrate having at least a first recess and at least a first through hole;
(c) positing said isolating substrate in said injection-molding device;
(d) injecting a conductive plastic material into said injection-molding device for forming an electrode set having a conductive strip disposed in said first recess and including an output terminal and a testing electrode disposed in said first through hole;
(e) providing a chemical reagent; and
(f) positing said chemical reagent on said testing electrode for testing an analyte in a sample.

2. The method according to claim 1, wherein said sample is a fluid solution and said chemical reagent tests said analyte and produces an electric measuring signal to be outputted via said testing electrode, wherein said electric measuring signal has a proportion with a concentration of said analyte.

3. The method according to claim 2, wherein said testing electrode is further electrically connected to an electronic meter.

4. The method according to claim 1, wherein said conductive plastic material is a resin mixed with at least one of a conductive carbon and a metal powder.

5. The method according to claim 4, wherein said resin is at least one of a thermosetting resin and a thermoplastic resin.

6. The method according to claim 4, wherein said resin is an epoxy resin.

7. The method according to claim 4, wherein said conductive carbon is at least one selected from a group consisting of a carbon black, a graphite power, a carbon fiber and a carbon nanotube.

8. The method according to claim 4, wherein said metal powder is one selected from a group consisting of a gold powder, a platinum powder, a palladium powder, and a rhodium powder.

9. The method according to claim 4, wherein said conductive carbon is of a weight density ranged from 3% to 80% in said conductive plastic material.

10. The method according to claim 4, wherein said metal powder is of a weight density ranged from 0.1% to 5% in said conductive plastic material.

11. The method according to claim 4, wherein said step (d) further comprises an antecedent step of:
mixing said resin with at least one of said conductive carbon and said metal powder for forming said conductive plastic material.

12. An electrochemical sensor, comprising:
an isolating substrate having at least a first recess and at least a first through hole;
an electrode set having a first conductive strip disposed in said first recess and having an output terminal and a first testing electrode disposed in said first through hole; and
a chemical reagent disposed on said first testing electrode for testing an analyte in a sample solution and producing a electric measuring signal to be outputted via said first testing electrode.

13. The electrochemical sensor according to claim 12 further comprising an isolating layer on said first conductive strip for isolating said first conductive strip.

14. The electrochemical sensor according to claim 12 wherein said first testing electrode serves as a working electrode, said isolating substrate further comprises a second recess and a second through hole, said electrode set further comprises a second conductive strip disposed in said second recess and having a second output terminal and a second testing electrode disposed in said second through hole, and said second testing electrode serves as a counter electrode.

15. The electrochemical sensor according to claim 14 wherein said isolating substrate further comprises a third recess and a third through hole, and said electrode set further comprises a third conductive strip disposed in said third recess and having a third output terminal and a third testing electrode disposed in said third through hole, wherein said third electrode has an Ag/AgCl film disposed on a surface thereof to serves as a reference electrode.

16. The electrochemical sensor according to claim 12, wherein said isolating substrate further comprises a flowing recess and a fluid inlet being of a unity with said first through hole.

17. The electrochemical sensor according to claim 16 further comprising a cover layer disposed on said isolating substrate for forming a capillary channel and a measuring section on said flowing recess and said fluid inlet.

18. The electrochemical sensor according to claim 17, wherein said isolating substrate further comprises a protruding spacer for urging against said cover layer and isolating said fluid sample and an adhesive of said cover layer.

19. The electrochemical sensor according to claim 17, wherein said cover layer is a plastic plate having a first printing conductive metal film that having a second output terminal and a second electrode terminal to serve as a counter electrode.

20. The electrochemical sensor according to claim 19, wherein said cover layer further comprises a second printing conductive metal film that having a third output terminal and a third electrode terminal to serve as a reference electrode.

21. The electrochemical sensor according to claim 20 further comprising a fourth testing electrode to be a detecting electrode to test a flow amount of said sample.

22. The electrochemical sensor according to claim 17, wherein said cover layer is one of a transparent layer and a translucent layer, has an opaque part and is shown a direction facilitating a user to observe how said sample flows.

23. The electrochemical sensor according to claim 17, wherein said cover layer is one of a textile cloth and a plastic mesh and has a mesh count from 20 to 150 per cm.

24. The electrochemical sensor according to claim 17, wherein said measuring section and said cover layer further comprise an inner side produced by means of a hydrophilic coating for facilitating said sample to fill up said measuring section.

25. The electrochemical sensor according to claim 16, wherein said flowing recess further comprises a placing recess for disposing said chemical reagent.

26. The electrochemical sensor according to claim 25, wherein a bottom of said measuring section and a top of said first testing electrode have a height difference, and said placing recess and said testing electrode top form a combination base for being coated with said chemical reagent.

27. The electrochemical sensor according to claim 26, wherein said chemical reagent is injected in a specific amount into said placing recess for forming an equal thickness.

28. The electrochemical sensor according to claim 12 further comprising a placing recess for disposing a meshed window.

29. The electrochemical sensor according to claim 28, wherein said electrode set and said chemical reagent are disposed in said placing recess to form said measuring section for said sample.

30. The electrochemical sensor according to claim 28 further comprising a cover layer disposed on said mashed window and connected with said isolating substrate, wherein said cover layer includes an opening for exposing a part of said meshed window.

31. The electrochemical sensor according to claim 30, wherein said cover layer is one of a textile cloth and a plastic mesh and has a mesh count from 20 to 150 per cm.

32. The electrochemical sensor according to claim 30, wherein said measuring section and said cover layer further comprise an inner side produced by means of a hydrophilic coating for facilitating said sample to fill up said measuring section.

33. The electrochemical sensor according to claim 12, wherein said isolating substrate further comprises an inlet for said sample being a fluid to be flowed therein and an air opening for facilitating a capillarity of said fluid sample.

34. The electrochemical sensor according to claim 12, wherein said first through hole and said first testing electrode respectively comprise a through-hole cross-section and a testing-electrode cross-section of the same area.

35. The electrochemical sensor according to claim 12, wherein said first through hole is disposed on a top of said isolating substrate.

36. The electrochemical sensor according to claim 35, wherein said first conductive strip is disposed on a bottom of said isolating substrate and has said first testing electrode disposed on a top of said isolating substrate via said first through hole, wherein said first testing electrode serves as a working electrode.

37. The electrochemical sensor according to claim 36 further comprising a first printing conductive metal film is printed on a top side of said isolating substrate, and said first printing conductive metal film having a second output terminal and a second electrode terminal for forming a second testing electrode, and said second testing electrode to serve as a counter electrode.

38. The electrochemical sensor according to claim 37 further comprising a second printing conductive metal film for forming a third output terminal and a third testing electrode.

39. The electrochemical sensor according to claim 38, wherein said third testing electrode further comprises an Ag/AgCl film to serve as a reference electrode.

40. The electrochemical sensor according to claim 12, wherein said isolating substrate is one selected from a group consisting of a polyvinyl chloride, a polypropylene, a polycarbonate, a polybutylene terephthalate, a polyethylene terephthalate, a modified polyphenylene oxide and an acrylonitrile butadiene styrene.

41. The electrochemical sensor according to claim 12, wherein said first conductive strip is made by means of molding via a conductive-strip molding device including said isolating substrate.

42. The electrochemical sensor according to claim 12, wherein said isolating substrate is made by means of molding via an isolating-substrate molding device including said first conductive strip.

43. The electrochemical sensor according to claim 12, wherein said first conductive strip and said isolating substrate are made in a double-injection-molding process.

44. The electrochemical sensor according to claim 12, wherein said first conductive strip is adhered to said isolating substrate via an adhesive.

45. The electrochemical sensor according to claim 12, wherein said first conductive strip further comprises a lead for electrically connecting said output terminal and said first testing electrode.

46. The electrochemical sensor according to claim 45, wherein said first testing electrode has a thickness ranged from 0.3 mm to 3 mm.

47. The electrochemical sensor according to claim 45, wherein said lead has a thickness ranged from 0.28 mm to 2.8 mm.

48. An electrochemical sensor, comprising:
an isolating substrate having a recess;
a first conductive device disposed in said recess and having an output terminal and a first testing electrode; and
a chemical reagent disposed on said first testing electrode for testing an analyte in a sample solution and producing an electric measuring signal to be outputted via said first testing electrode.

49. The electrochemical sensor according claim 48, wherein said first conductive device is a first conductive strip, and said recess further comprises a first recess for disposing said first conductive strip therein and a first through hole for disposing said first testing electrode therein.

50. The electrochemical sensor according to claim 48 further comprising a printing metal film having a printing output terminal and a connecting terminal, wherein said first conductive device is a first conductive pad, said recess further includes a first through hole, and said printing metal film is printed on said isolating substrate and said connecting terminal electrically connects to said output terminal of said conductive pad for receiving said measuring signal from said first testing electrode

51. The electrochemical sensor according to claim 50, wherein said first through hole connects with an extended recess for disposing therein an extended base of said first conductive pad.

52. An electrochemical sensor, comprising:
a conductive set having a first conductive device having a first testing electrode;
an isolating substrate having at least a first recess for disposing said first testing electrode;
a first printing metal film printed on said isolating substrate and having an output terminal and a connecting terminal connected with said first conductive device; and
a chemical reagent disposed on said first testing electrode for testing an analyte in a sample and producing an electric measuring signal to be outputted via said first testing electrode.

53. The electrochemical sensor according to claim 52, wherein said isolating substrate further comprises a second recess for disposing a second conductive device of said conductive set.

54. The electrochemical sensor according to claim 53 further comprising a second printing metal film that having an second output terminal and a second connecting terminal connected with said second conductive device.

55. The electrochemical sensor according to claim 54, wherein said first testing electrode serves as a working electrode and said second conductive device further serves as a counter electrode.

56. The electrochemical sensor according to claim 55, wherein said isolating substrate further comprises a third recess for disposing a third conductive device of said conductive set.

57. The electrochemical sensor according to claim 56 further comprising a third printing metal film that having a third output terminal and a third connecting terminal for connecting said third conductive device.

58. The electrochemical sensor according to claim 56, wherein said third conductive device further comprises an Ag/AgCl film to serve as a reference electrode.

59. The electrochemical sensor according to claim 56, wherein said first printing metal film, said second printing metal film and third printing metal film are printed on said isolating substrate and a back side of said working area.

60. The electrochemical sensor according to claim 52, wherein said first testing electrode is a working electrode having a working area on a top side of said isolating substrate.

61. The electrochemical sensor according to claim 52, wherein said first recess is a U-shaped recess, and said first conductive device is a U-shaped conductive device and has an end serving as said first testing electrode and another end serving as a connecting terminal connected with said first conductive metal film for outputting said electric measuring signal of said first testing electrode.

62. The electrochemical sensor according to claim 61, wherein said first printing metal film and a working area of said first testing electrode are disposed on the same side.

63. The electrochemical sensor according to claim 62 further comprising a second printing metal film having a output terminal and a electrode terminal that printed on said isolating substrate to serve as a second testing electrode and second output terminal.

64. The electrochemical sensor according to claim 63 further comprising an isolating layer for covering said first printing metal film and said second printing metal film.

65. The electrochemical sensor according to claim 64, wherein said isolating layer further comprises an inlet for flowing therethrough said sample being a fluid and a C-shaped opening for forming a measuring section.

66. The electrochemical sensor according to claim 65 further comprising a covering layer and an air hole for forming a capillarity channel in said measuring section.

67. The electrochemical sensor according to claim 66 further comprising a third printing metal film having a output terminal and a electrode terminal that is printed on said isolating substrate to serve as a third testing electrode and third output terminal, wherein said third testing electrode further comprises a Ag/AgCl film to serve as a reference electrode.

68. An electrochemical sensor, comprising:
a conductive piece having an outputting terminal and a first testing electrode;
an isolating substrate connected to said conductive piece and having a through hole for disposed said first testing electrode; and
a chemical reagent disposing on said first testing electrode for testing a sample solution and producing an electric measuring signal to be outputted via said first testing electrode.

69. The electrochemical sensor according to claim 68, wherein said first testing electrode is a protruding part of said conductive piece for being disposed in said through hole of said isolating substrate.

70. The electrochemical sensor according to claim 68, wherein said isolating substrate further comprises a first printing metal film to be a second testing electrode and a second output terminal.

71. The electrochemical sensor according to claim 70, wherein said isolating substrate further comprises a second printing metal film to be a third testing electrode and a third output terminal.

72. The electrochemical sensor according to claim 71, wherein said third testing electrode further comprises an Ag/AgCl surface to be a reference electrode.

73. The electrochemical sensor according to claim 71, wherein said first testing electrode, said second testing electrode and said third testing electrode are a working electrode, a counter electrode and a reference electrode respectively.

74. An electrochemical sensor, comprising:
a conductive sheet made by plastic-injection process and having an outputting terminal and a first testing electrode;
an isolating layer connected to said conductive sheet and having a through hole for exposing a surface area of said first testing electrode meanwhile making a placing recess on a top of said first testing electrode; and
a chemical reagent disposing on said placing recess for testing an analyte in a sample solution and producing an electric measuring signal to be outputted via said first testing electrode.

75. The electrochemical sensor according to claim 74, wherein a top of said isolating layer and a top of said first testing electrode have a height difference to form said placing recess, meanwhile said chemical reagent is injected in a specific amount into said placing recess for forming an equal thickness.

76. The electrochemical sensor according to claim 75, wherein said first testing electrode serves as a working electrode, and wherein said isolating layer further comprises a first printing metal film to be a second testing electrode and a second output terminal.

77. The electrochemical sensor according to claim 76, wherein said second testing electrode serves as a counter electrode, and said isolating layer further comprises a second printing metal film to be a third testing electrode and a third output terminal, meanwhile said third testing electrode further comprises an Ag/AgCl surface to be a reference electrode.

78. An electrochemical electrode, comprising:
a conductive strip having an outputting terminal and a first testing electrode; and
an isolating substrate connected to said conductive strip and having a through hole for disposed said first testing electrode.

79. The electrochemical electrode according to claim 78 further comprising a reagent matrix layer on a surface of said first testing electrode to modify said first testing electrode to be said working electrode.

80. The electrochemical electrode according to claim 79, wherein said reagent matrix layer includes at least one of an enzyme, a PH buffer, a surfactant, an redox mediator, a hydrophilic polymer compound.

81. The electrochemical electrode according to claim 80, wherein said enzyme is a glucose oxidase for testing a concentration of a blood glucose in a blood.

82. The electrochemical electrode according to claim 80, wherein said enzyme is an uricase for testing a concentration of a uric acid in a blood.

83. The electrochemical electrode according to claim 80, wherein said enzyme is a cholesterol esterase and a cholesterol oxidase for testing a concentration of cholesterol in a blood.

84. The electrochemical electrode according to claim 78 wherein said first testing electrode serves as a counter electrode.

85. The electrochemical electrode according to claim 78 further comprising a Ag/AgCl layer on a surface of said first testing electrode to modify said first testing electrode to be a Ag/AgCl modified reference electrode.
